(19) United States
(12) Patent Application Publication
(10) Pub. No.: US 2018/0194692 A1
(43) Pub. Date: Jul. 12, 2018

(54) BARIUM TITANATE FOAM CERAMICS AND PREPARATION METHOD THEREOF

(71) Applicant: SOOCHOW UNIVERSITY, Suzhou (CN)

(72) Inventors: Guozheng LIANG, Suzhou (CN); Longhui ZHENG, Suzhou (CN); Aijuan GU, Suzhou (CN); Shuhui PIAO, Suzhou (CN); Li YUAN, Suzhou (CN)

(21) Appl. No.: 15/740,802

(22) PCT Filed: Nov. 29, 2016
(86) PCT No.: PCT/CN2016/107787

§ 371 Date: Dec. 29, 2017

(30) Foreign Application Priority Data
Jan. 11, 2016 (CN) 201610014637.5

(51) Int. Cl. C04B 38/08; C04B 38/06; C04B 35/468; C04B 35/634; C04B 35/636; C08L 25/08; C08L 27/06; C08L 33/14; C08L 33/26; C08L 75/04

(52) U.S. Cl. CPC C04B 38/08; C04B 38/061; C04B 35/468; C04B 35/63416; C04B 35/6365; C04B 2235/6562; C08L 27/06; C08L 33/14; C08L 33/26; C08L 75/04; C04B 2235/5454; C08L 25/08

(57) ABSTRACT

Barium titanate foam ceramics and a preparation method thereof are disclosed. An organic binder, an organic rheological agent and an organic dispersing agent are used as auxiliaries; deionized water is used as a solvent; nanometer barium titanate is used as a ceramic raw material; and all of same are mixed and ground so as to form a slurry with a certain solid content. A pretreated polymer sponge is impregnated into the slurry for slurry coating treatment and then dried to obtain a barium titanatefoam ceramic blank with an ideal slurry coating and without blocking holes, and same is then sintered so as to obtain a barium titanate foam ceramic. The foam ceramic has a three-dimensional network skeleton structure, and the skeleton of the foam ceramic is composed of pure barium titanate ceramic of a single chemical composition.

### FIELD OF THE INVENTION

The present invention relates to a kind of barium titanate foam ceramics and preparation method thereof, it belongs to the technical field of foam ceramics.

### TECHNICAL BACKGROUND

Foam ceramic (FC) is a new type of porous material with three-dimensional network skeleton and interconnecting pore channels produced by a special process. The mature methods for preparing FCs are foaming process, adding pore forming agents, and polymer foam replication. Among which, the polymer foam replication has the advantages of simple process and ability of batch production. However, in this process, most of the raw materials and inorganic additives for preparing ceramic slurry are ceramics with microns or larger sizes, and they usually need to be ground for a long time to get slurry with uniform dispersion and good fluid.

Due to the advantages of FCs with good chemical stability, high strength, high temperature resistance and thermal shock resistance, low density, high porosity and large specific surface area, etc, it is widely used in the preparation of automobile exhaust devices, energy-saving insulation, industrial wastewater treatment, chemical catalyst carrier and biological materials, etc. Note that, generally, the available FCs are end-use products that are used directly, they are not used for fabricating resin matrix composites with high dielectric constant.

At present, the FC mainly includes silicon carbide (SiC), alumina (Al₂O₃) and silicon nitride (Si₃N₄). Their dielectric constants are low (usually less than 12), and cannot meet the performance requirements of high dielectric constant materials. Meanwhile, the strengths of these available FCs are low, in order to get improved its strength, a large amount of inorganic additives is often added in the preparation process, so that it is difficult to obtain pure FCs with a single chemical composition. For example, Chinese invention patent entitled “Alumina foam ceramic filter” (CN 101164658) disclosed a kind of alumina foam ceramic filter used for filtering and purifying of aluminum, aluminum alloy and copper, so which is mainly composed of alumina. Silica, talc and kaolin were used as sintering additives in the process of preparation of the foam ceramic, which is a kind of alumina foam ceramic containing some other impurities. Another Chinese invention patent entitled “Silicon nitride foam ceramic and preparation method thereof” (CN 102093076A) disclosed a kind of silicon nitride foam ceramic that using silicon nitride as the main component, yttrium oxide, alumina and silica as sintering additives, and the foam ceramic was prepared through polymer foam replication.

It is well known that dielectric property is one of the most sensitive performances to structural variations among the properties of materials. Therefore, the presence of impurities is not good for retaining the excellent dielectric properties of original ceramics.

Barium titanate has excellent mechanical strength, high dielectric constant, low dielectric loss, prominent ferroelectric, piezoelectric and positive temperature coefficient properties, which is ideal for preparing materials with high dielectric, ferroelectric and piezoelectric effects. However, so far, there has been no report about barium titanate foam ceramics and preparation method thereof. Considering the performance advantages of main application fields of barium titanate, pure barium titanate foam ceramic with a single chemical composition can take advantage of good performances and thus satisfies the requirement of applications. Obviously, this leads to a problem with low strength. Therefore, how to fabricate pure barium titanate foam ceramics with high strength and single chemical composition is a challenging project with great significance.

### SUMMARY OF THE INVENTION

In order to solve the problems in available technologies, the purpose of the present invention is to provide a kind of barium titanate foam ceramics with high strength, high dielectric constant skeleton and a single chemical composition and preparation method thereof.

To achieve above purpose, the present invention adopts the following technical solution:

A preparation method of barium titanate foam ceramics, wherein comprising the following steps:

(1) by weight, 100 parts of nano barium titanate and 30 to 120 parts of an aqueous solution of organic binder with a concentration of 1 to 15 wt % are sufficiently ground to obtain a slurry A; 10 to 80 parts of an aqueous solution of organic rheological agent with a concentration of 0.5 to 3 wt % are added into the slurry A, and the mixture is sufficiently ground to obtain a slurry B; 20 to 80 parts of an aqueous solution of organic dispersant with a concentration of 0.5 to 3 wt % are added into the slurry B, and the mixture is sufficiently ground to obtain a slurry C;

(2) a polymer sponge having a specification of 15 to 35 PPI is soaked in an aqueous solution of sodium hydroxide with a concentration of 5 to 20 wt %, and then heated up to 50 to 75° C. and kept at that temperature for 2 to 6 h, the polymer sponge is taken out and washed with deionized water, dried to obtain a polymer sponge D; at room temperature, the polymer sponge D is soaked in an aqueous surfactant solution with a concentration of 0.5 to 3 wt % for 2 to 6 h, then taken out and removing the excess surfactant, after dried at 40 to 80° C., a pretreated polymer sponge E is obtained;

(3) the pretreated polymer sponge E is soaked in the slurry C prepared in step (1), and maintained for 1 to 10 min at room temperature, after hanging pulp, the excess slurry in the sponge is removed by extrusion, and the sponge is dried at 40 to 80° C.; repeating the processes of hanging pulp and drying for 1 to 7 times to obtain a green body of foam ceramics based on barium titanate;

(4) the green body of barium titanate foam ceramics prepared in step (3) is heated from room temperature to 100-300° C. at a rate of 0.5-5° C./min, and then raised to 500-700° C. at a rate of 0.5-5° C./min and maintained at 500-700° C. for 0.5-2 h, after that, continuously heated to 1000-1500° C. at a rate of 2-10° C./min and kept at 1000-1500° C. for 1-5 h, cool with the furnace to room temperature to obtain barium titanate foam ceramics.

In the above solution, the polymer material of said polymer sponge is selected from polyurethane, polystyrene, or polyvinyl chloride.

The average diameter of nano barium titanate is less than or equal to 100 nm.

The organic binder is one or more selected from polyvinyl alcohol, carboxymethyl cellulose and methyl cellulose.

The organic rheological agent is one or more selected from carboxymethyl cellulose and hydroxyhexyl cellulose.

The organic dispersant is one or more selected from polyethyleneimine, polyacrylamide and polyacrylic acid amine.

The surfactant is one or more selected from carboxymethyl cellulose and polyethyleneimine.

The technical solution of this invention also comprises a kind of barium titanate foam ceramics obtained by using above mentioned preparation method.

The present invention uses nano barium titanate as inorganic ceramic composition of the slurry, this takes full use of nano effect, the resultant barium titanate foam ceramics have high strength, the mechanism behind includes: Firstly, the grains of nano ceramics have many more defects and high surface area, so the sintering activity is large to obtain ceramics with high strength; secondly, nanoscale grains also can restrain the development of microcracks, which will not easily cause rupture of transcrystalline, and thus improve its fracture toughness, wearability and strength; thirdly, nanoparticles can form slurry with good dispersion and uniformity, so the body is dense and not easy to block holes. Particularly, this invention uses organic additives for preparing pure foam ceramics with a single chemical composition; and the decomposition of organic additives produces small holes at high temperature, so using nano barium titanate can enhance the compactness of the foam ceramic skeleton; fourthly, nanoparticles can also increase the density of the sintered body.

At the same time, nano barium titanate with high dielectric constant in this invention is chosen as the raw material, during the sintering process, other organic additives will be decomposed, and barium titanate is further ceramization at high temperature, so the foam ceramics exhibit higher dielectric constant, that is, the resultant barium titanate foam ceramics consist of skeleton with high dielectric constant.

Compared with prior arts, this invention has following advantages:

1. The barium titanate foam ceramics prepared in this invention are foam ceramics that have single chemical composition and pure barium titanate skeleton, this is because inorganic materials are not added or “in situ” formed during the preparation process, instead, organic additives decompose during the high temperature sintering process, resulting in pure barium titanate foam ceramics with high strength, high dielectric constant skeleton and single chemical composition.

2. Different from the slurry in the existing technology using ceramic raw materials and inorganic additives with microns sizes, nano barium titanate as inorganic additives of the slurry, and organic additives are used in this invention. Therefore, it does not need to be ground using ball mill for a long time, instead, slurry with uniform dispersion and excellent fluidity can be obtained through simple grinding, with the advantages of high efficiency and energy-saving.

3. The barium titanate foam ceramics prepared in this invention integrate excellent dielectric properties of barium titanate, high porosity and low density of foam ceramic, which provide tremendous application foreground in the fields of further modifications and applications of barium titanate foam ceramics, as well as developing novel dielectric foam ceramics and high performance of the barium titanate foam ceramic/polymer composites.

4. The method for the preparation of barium titanate foam ceramics provided in this invention is simple and has wide applicability, so it is suitable for industrial production.

### BRIEF DESCRIPTION OF THE DRAWINGS

FIG. 1 is stereo microscope images of polyurethane sponge E, green body of barium titanate foam ceramics and barium titanate foam ceramics prepared in EMBODIMENT 1, and barium titanate foam ceramics prepared in EMBODIMENT 2 of this invention.

FIG. 2 is X-ray diffraction patterns of barium titanate foam ceramics prepared in EMBODIMENTS 1, 3, 4 and 5 of this invention.

FIG. 3 is a scanning electron microscope image (×1,000) of barium titanate foam ceramics prepared in EMBODIMENT 5 in this invention.

FIG. 4 gives plots reflecting frequency dependence of dielectric constant of barium titanate foam ceramic/cyanate ester resin composite prepared in CONTROL EXAMPLE 1, and barium titanate/cyanate ester resin composite prepared in CONTROL EXAMPLE 2.

FIG. 5 is compressive strength of barium titanate foam ceramics prepared in EMBODIMENTS 5, 6 and 7.

### DETAILED DESCRIPTION OF THE INVENTION

The technical solution of this invention is further described by combining drawings, embodiments and control examples as follows.

### Embodiment 1

1) Preparation of Slurries

20 g of barium titanate (the average diameter is 100 nm) and 10 g of aqueous polyvinyl alcohol solution with a concentration of 10 wt % were sufficiently ground to obtain a slurry A; 5 g of aqueous carboxymethyl cellulose solution with a concentration of 2 wt % was added into the slurry A, and the mixture was sufficiently ground to obtain a slurry B; 10 g of aqueous polyacrylamide solution with a concentration of 1 wt % was added into the slurry B, and the mixture was sufficiently ground to obtain a slurry C.

2) Treatment of Polyurethane Sponge

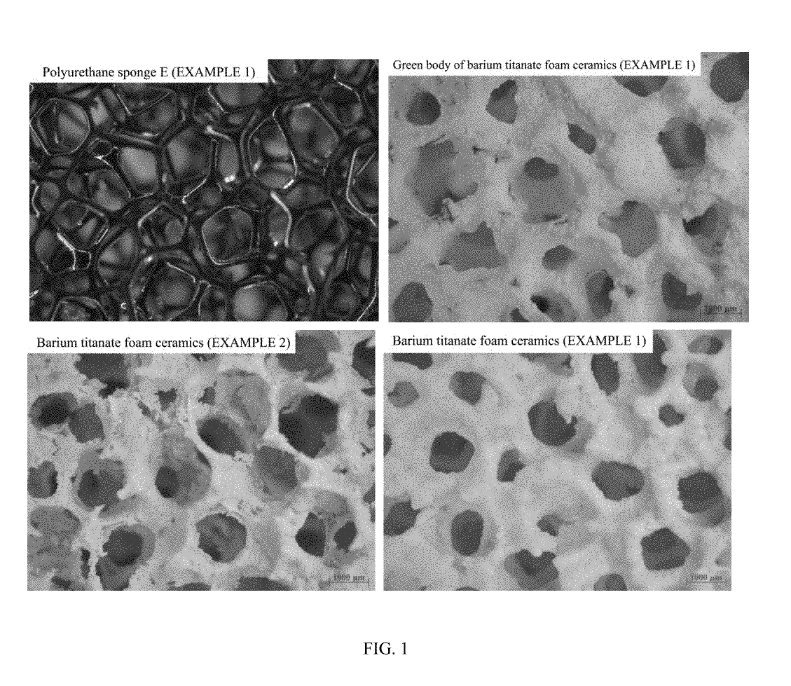

The polyurethane sponge having a specification of 25 PPI was soaked in an aqueous sodium hydroxide solution with a concentration of 15 wt %, and then heated up to 60° C. and kept at that temperature for 3.5 h; the polyurethane sponge was taken out and washed with deionized water, following by drying to obtain a polyurethane sponge D; at room temperature, the polyurethane sponge D was soaked in an aqueous carboxymethyl cellulose solution with a concentration of 1 wt % for 3 h; then took out and removed the excess carboxymethyl cellulose solution, after dried at 60° C., a pretreated polyurethane sponge E was obtained. Its stereo microscope image is shown in FIG. 1.

3) Preparation of Green Body of Barium Titanate Foam Ceramics

The pretreated polyurethane sponge E was soaked in the slurry C prepared in step 1) and maintained for 5 min at room temperature; after hanging pulp, the excess slurry in the sponge was removed by extrusion, and the sponge was dried at 40° C.; repeating processes of hanging pulp and drying for 4 times, a green body of foam ceramics based on barium titanate with even coating and no blocks was obtained. Its stereo microscope image is shown in FIG. 1.

4) Preparation of Barium Titanate Foam Ceramics

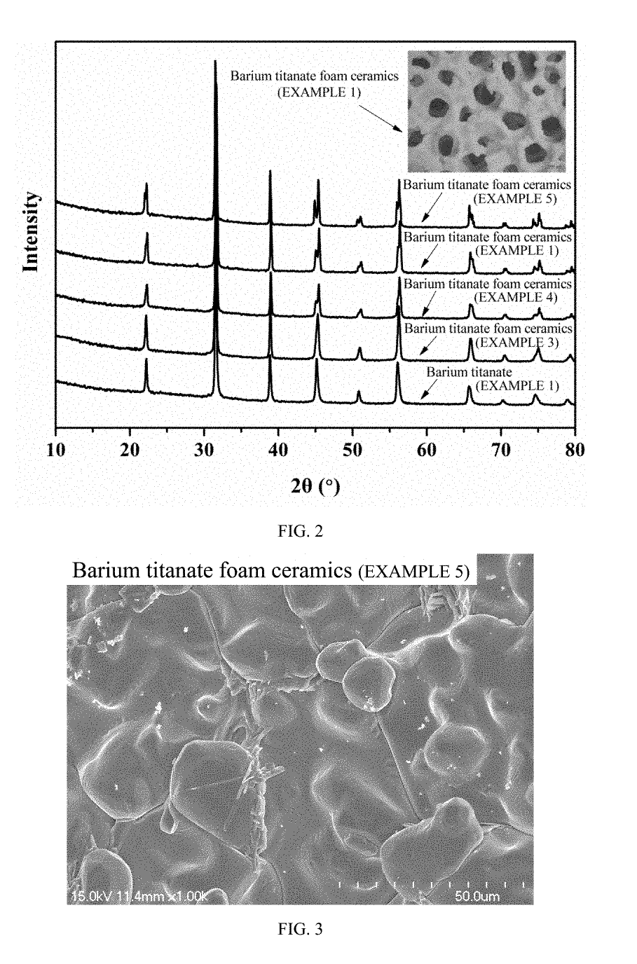

The green body of barium titanate foam ceramics prepared in step 3) was heated from room temperature to 200° C. at a rate of 2° C./min, and then raised to 600° C. at a rate of 1° C./min and maintained at 600° C. for 1 h; after that, continuously heated to 1200° C. at a rate of 5° C./min and kept at that temperature for 2 h; after the furnace was cooled to room temperature, barium titanate foam ceramics were obtained. The stereo microscope image and X-ray diffraction pattern of the barium titanate foam ceramics are shown in FIGS. 1 and 2, respectively.

### Embodiment 2

1) Preparation of Green Body of Barium Titanate Foam Ceramics

The pretreated polyurethane sponge E in EMBODIMENT 1 was soaked in the slurry C (EMBODIMENT 1) and maintained for 5 min at room temperature; after hanging pulp, the excess slurry in the sponge was removed by extrusion, and the sponge was dried at 40° C.; repeating processes of hanging pulp and drying for 2 times, a green body of foam ceramics based on barium titanate with even coating and no blocks was obtained.

2) Preparation of Barium Titanate Foam Ceramics

The green body of barium titanate foam ceramics prepared in step 1) was heated from room temperature to 200° C. at a rate of 2° C./min, and then raised to 600° C. at a rate of 1° C./min and maintained at 600° C. for 1 h; after that, continuously heated to 1200° C. at a rate of 5° C./min and kept at that temperature for 2 h; after the furnace was cooled to room temperature, barium titanate foam ceramics were obtained. Its stereo microscope image is shown in FIG. 1.

FIG. 1 is stereo microscope images of polyurethane sponge E, green body of barium titanate foam ceramics and barium titanate foam ceramics prepared in EMBODIMENT 1 and barium titanate foam ceramics prepared in EMBODIMENT 2 of this invention. As shown in FIG. 1, barium titanate is evenly coated on the skeleton of the sponge after the pretreated polyurethane sponge E was coated with the slurry (EMBODIMENT 1). After sintering, the polyurethane sponge is decomposed at high temperature to obtain barium titanate foam ceramics with even pore distribution and no blocks (EMBODIMENTS 1 and 2). Compared with the barium titanate foam ceramics prepared in EMBODIMENT 2, the barium titanate foam ceramics prepared in EMBODIMENT 1 have a stouter skeleton because the content of slurry on the sponge skeleton increases as the number of coatings increases.

### Embodiment 3

The green body of barium titanate foam ceramics prepared in EMBODIMENT 1 was heated from room temperature to 200° C. at a rate of 2° C./min, and then raised to 600° C. at a rate of 1° C./min and maintained at 600° C. for 1 h; after that, continuously heated to 1000° C. at a rate of 5° C./min and kept at that temperature for 2 h; after the furnace was cooled to room temperature, barium titanate foam ceramics were obtained. Its X-ray diffraction pattern is shown in FIG. 2.

### Embodiment 4

The green body of barium titanate foam ceramics prepared in EMBODIMENT 1 was heated from room temperature to 200° C. at a rate of 2° C./min, and then raised to 600° C. at a rate of 1° C./min and maintained at 600° C. for 1 h; after that, continuously heated to 1100° C. at a rate of 5° C./min and kept at that temperature for 2 h; after the furnace was cooled to room temperature, barium titanate foam ceramics were obtained. Its X-ray diffraction pattern is shown in FIG. 2.

### Embodiment 5

The green body of barium titanate foam ceramics prepared in EMBODIMENT 1 was heated from room temperature to 200° C. at a rate of 2° C./min, and then raised to 600° C. at a rate of 1° C./min and maintained at 600° C. for 1 h; after that, continuously heated to 1300° C. at a rate of 5° C./min and kept at that temperature for 2 h; after the furnace was cooled to room temperature, barium titanate foam ceramics were obtained. Its X-ray diffraction pattern, scanning electron microscope image and compressive strength are shown in FIGS. 2, 3 and 5, respectively.

FIG. 2 displays X-ray diffraction patterns of barium titanate foam ceramics prepared in EMBODIMENTS 1, 3, 4 and 5 of this invention. It can be seen that nano barium titanate exhibits significant diffraction peaks at 22.1°, 31.6°, 38.9°, 45.2°, 50.8°, 56.1°, 65.8°, 70.2°, 74.6° and 78.9°, corresponding to crystal planes of (100), (110), (111), (002)/(200), (210), (211), (220), (221), (310) and (113) (JCPDS No. 5-0626), respectively. Whether 20 at 45.2° is split into two diffraction peaks or not is an effective evidence for judging the crystalline form of barium titanate. Since the barium titanate foam ceramics prepared in EMBODIMENT 3 do not exhibit a split peak at 45.2°, it proving that the barium titanate foam ceramics prepared in EMBODIMENT 3 are cubic crystalloid. In contrast to EMBODIMENT 3, each pattern of the barium titanate foam ceramics prepared in EMBODIMENTS 1, 4 or 5 shows two split peaks at 45.2°, indicating that the crystalline form of the barium titanate foam ceramics transforms into tetragonal phase, and the intensity of the split peak increases obviously with the increase of sintering temperature, indicating that the content of tetragonal phase in barium titanate foam ceramics increases. Those results show that changing the sintering temperature can control the crystalline form and the content of different crystal phases of barium titanate foam ceramics. Note that there is no other impurity peak in all X-ray diffraction patterns, suggesting that organic additives have decomposed during the sintering process to obtain pure barium titanate foam ceramics with a single chemical composition.

FIG. 3 shows a scanning electron microscope image of barium titanate foam ceramics prepared in EMBODIMENT 5 of this invention. As can be seen, after the green body of foam ceramics was sintered at high temperature, the organic additives have decomposed, the barium titanate grains grow and become larger, consequently, skeleton of barium titanate foam ceramics with good density are obtained.

Above results indicate that barium titanate foam ceramics with a single chemical composition and good compactness have been successfully prepared.

### Control Example 1

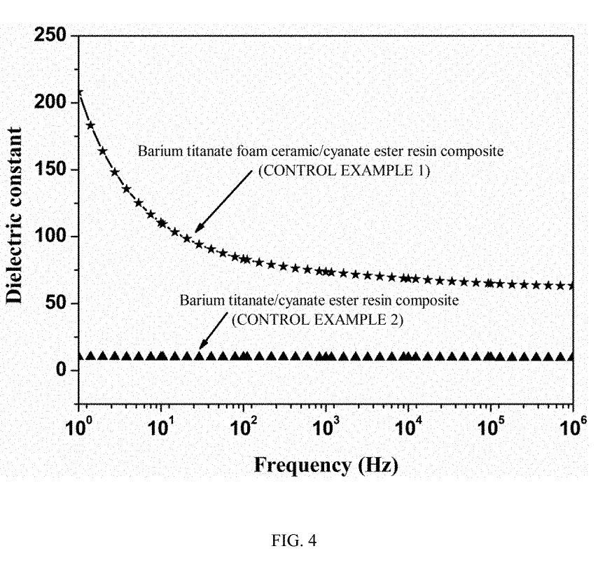

Preparation of barium titanate foam ceramic/cyanate ester resin composite: the barium titanate foam ceramics prepared in EMBODIMENT 1 were placed in a mold and preheated at 160° C. in an oven; 2,2-bis(4-cyanatophenyl)propane (bisphenol A cyanate ester) was melted at 160° C. for 1 h to obtain an solution, which was poured into the preheated barium titanate foam ceramics and degassed under vacuum at 160° C. for 0.5 h; followed by curing and postcuring using the procedures 160° C./2 h+180° C./2 h+200° C./2 h+220° C./2 h, and 240° C./4 h, successively; after slowly cooled to room temperature, barium titanate foam ceramic/cyanate ester resin composite was obtained, wherein the content of cyanate ester resin is 69.2 vol %. The plot reflecting frequency dependence of dielectric content of composite is shown in FIG. 4.

### Control Example 2

Preparation of Barium Titanate/Cyanate Ester Resin Composite:

21.3 g of barium titanate (the average diameter is 100 nm) was blended with 10 g of bisphenol A cyanate ester with stirring at 150° C., the mixture was dispersed under sonication for 10 min at 90° C. and then prepolymerization maintained at 150° C. for 0.5 h to get a prepolymer; which was poured into the preheated mold and degassed under vacuum at 160° C. for 0.5 h, followed by curing and postcuring using the procedures 160° C./2 h+180° C./2 h+200° C./2 h+220° C./2 h, and 240° C./4 h, successively, barium titanate/cyanate ester resin composite was obtained, wherein the content of cyanate ester resin is 69.2 vol %. The plot reflecting frequency dependence of dielectric content of composite is shown in FIG. 4.

FIG. 4 gives plots reflecting frequency dependence of dielectric constant of barium titanate foam ceramic/cyanate ester resin composites prepared in CONTROL EXAMPLE 1 and barium titanate/cyanate ester resin composite prepared in CONTROL EXAMPLE 2. When the functional fillers with equal loading, the dielectric constant of barium titanate foam ceramic/cyanate ester resin composite is higher than that of barium titanate/cyanate ester resin composite, for example, the dielectric constant (at 100 Hz) of barium titanate foam ceramic/cyanate ester resin composite prepared in CONTROL EXAMPLE 1 is 83.3, about 8.4 times of barium titanate/cyanate ester resin composite (9.9) prepared in CONTROL EXAMPLE 2. This is because when barium titanate foam ceramics with three-dimensional network skeleton are used as functional filler, uniform distribute of barium titanate in the composite, and thus the composite shows greatly improved dielectric constant. Therefore, the pure barium titanate foam ceramics with a single chemical composition provided in this invention are helpful to prepare composites with high dielectric constant.

### Embodiment 6

1) Preparation of Green Body of Barium Titanate Foam Ceramics

The pretreated polyurethane sponge E in EMBODIMENT 1 was soaked in the slurry C (EMBODIMENT 1) and maintained for 5 min at room temperature; after hanging pulp, the excess slurry in the sponge was removed by extrusion, and the sponge was dried at 40° C.; repeating processes of hanging pulp and drying for 3 times, a green body of foam ceramics based on barium titanate with even coating and no blocks was obtained.

2) Preparation of Barium Titanate Foam Ceramics

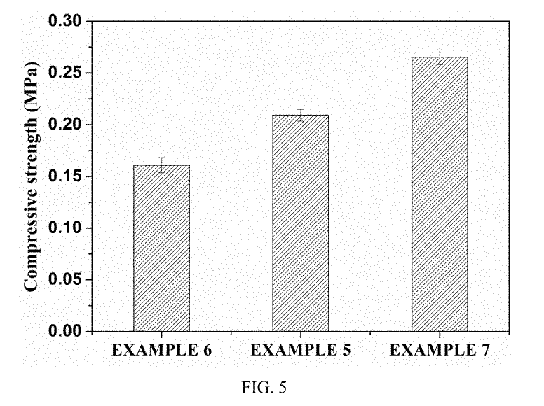

The green body of barium titanate foam ceramics prepared in step 1) was heated from room temperature to 200° C. at a rate of 2° C./min, and then raised to 600° C. at a rate of 1° C./min and maintained at 600° C. for 1 h; after that, continuously heated to 1300° C. at a rate of 5° C./min and kept at that temperature for 2 h; after the furnace was cooled to room temperature, barium titanate foam ceramics were obtained. Its compressive strength is shown in FIG. 5.

### Embodiment 7

1) Preparation of Green Body of Barium Titanate Foam Ceramics

The pretreated polyurethane sponge E in EMBODIMENT 1 was soaked in the slurry C (EMBODIMENT 1) and maintained for 5 min at room temperature; after hanging pulp, the excess slurry in the sponge was removed by extrusion, and the sponge was dried at 40° C.; repeating processes of hanging pulp and drying for 5 times, a green body of foam ceramics based on barium titanate with even coating and no blocks was obtained.

2) Preparation of Barium Titanate Foam Ceramics

The green body of barium titanate foam ceramics prepared in step 1) was heated from room temperature to 200° C. at a rate of 2° C./min, and then raised to 600° C. at a rate of 1° C./min and maintained at 600° C. for 1 h; after that, continuously heated to 1300° C. at a rate of 5° C./min and kept at that temperature for 2 h; after the furnace was cooled to room temperature, barium titanate foam ceramics were obtained. Its compressive strength is shown in FIG. 5.

FIG. 5 gives compressive strengths of barium titanate foam ceramics prepared in EMBODIMENTS 5, 6 and 7 in this invention. It can be seen that compressive strength of barium titanate foam ceramics increases as the number of coatings increases. When the number of coatings is 4, 5 or 6, the compressive strength of barium titanate foam ceramics is 0.16 MPa, 0.21 MPa or 0.27 MPa. Results show that the resultant barium titanate foam ceramics have certain strength to guarantee that the titanium titanate ceramics will not be destroyed during the preparation of composites.

### Embodiment 8

Preparation of Barium Titanate Foam Ceramics

The green body of barium titanate foam ceramics prepared in EMBODIMENT 1 was heated from room temperature to 200° C. at a rate of 2° C./min, and then raised to 600° C. at a rate of 1° C./min and maintained at 600° C. for 2 h; after that, continuously heated to 1400° C. at a rate of 5° C./min and kept at that temperature for 2 h; after the furnace was cooled to room temperature, barium titanate foam ceramics were obtained.

### Embodiment 9

Preparation of Barium Titanate Foam Ceramics

The green body of barium titanate foam ceramics prepared in EMBODIMENT 1 was heated from room temperature to 200° C. at a rate of 2° C./min, and then raised to 600° C. at a rate of 1° C./min and maintained at 600° C. for 1 h; after that, continuously heated to 1500° C. at a rate of 5° C./min and kept at that temperature for 1 h; after the furnace was cooled to room temperature, barium titanate foam ceramics were obtained.

### Embodiment 10

1) Preparation of Slurries

20 g of barium titanate (the average diameter is 30 nm) and 24 g of aqueous carboxymethyl cellulose solution with a concentration of 1 wt % were sufficiently ground to obtain a slurry A; 5 g of aqueous carboxymethyl cellulose solution with a concentration of 2 wt % was added into the slurry A, and the mixture was sufficiently ground to obtain a slurry B; 16 g of aqueous polyacrylamide solution with a concentration of 0.5 wt % was added into the slurry B, and the mixture was sufficiently ground to obtain a slurry C.

2) Treatment of Polystyrene Sponge

The polystyrene sponge having a specification of 25 PPI was soaked in an aqueous sodium hydroxide solution with a concentration of 5 wt %, and then heated up to 75° C. and kept at that temperature for 6 h; the polystyrene sponge was taken out and washed with deionized water, following by drying to obtain a polystyrene sponge D; at room temperature, the polystyrene sponge D was soaked in an aqueous carboxymethyl cellulose solution with a concentration of 1 wt % for 6 h; then took out and removed the excess carboxymethyl cellulose solution, after dried at 60° C., the pretreated polystyrene sponge E was obtained.

3) Preparation of Green Body of Barium Titanate Foam Ceramics

The pretreated polystyrene sponge E was soaked in the slurry C prepared in step 1) and maintained for 1 min at room temperature; after hanging pulp, the excess slurry in the sponge was removed by extrusion, and the sponge was dried at 50° C.; repeating processes of hanging pulp and drying for 1 times, a green body of foam ceramics based on barium titanate with even coating and no blocks was obtained.

4) Preparation of Barium Titanate Foam Ceramics

The green body of barium titanate foam ceramics prepared in step 3) was heated from room temperature to 200° C. at a rate of 0.5° C./min, and then raised to 600° C. at a rate of 1° C./min and maintained at 600° C. for 1 h; after that, continuously heated to 1200° C. at a rate of 5° C./min and kept at that temperature for 5 h; after the furnace was cooled to room temperature, barium titanate foam ceramics were obtained.

### Embodiment 11

1) Preparation of Slurries

20 g of barium titanate (the average diameter is 50 nm) and 6 g of aqueous polyvinyl alcohol solution with a concentration of 10 wt % and 18 g of aqueous carboxymethyl cellulose solution with a concentration of 1 wt % were sufficiently ground to obtain a slurry A; 5 g of aqueous carboxymethyl cellulose solution with a concentration of 0.5 wt % and 5 g of aqueous hydroxyhexyl cellulose solution with a concentration of 3 wt % were added into the slurry A, and the mixture was sufficiently ground to obtain a slurry B; 10 g of aqueous polyacrylamide solution with a concentration of 1 wt % was added into the slurry B, and the mixture was sufficiently ground to obtain a slurry C.

2) Treatment of Polyurethane Sponge

The polyurethane sponge having a specification of 25 PPI was soaked in an aqueous sodium hydroxide solution with a concentration of 20 wt %, and then heated up to 50° C. and kept at that temperature for 2 h; the polyurethane sponge was taken out and washed with deionized water, following by drying to obtain a polyurethane sponge D; at room temperature, the polyurethane sponge D was soaked in an aqueous polyethyleneimine solution with a concentration of 3 wt % for 2 h; then took out and removed the excess polyethyleneimine solution, after dried at 80° C., the pretreated polyurethane sponge E was obtained.

3) Preparation of Green Body of Barium Titanate Foam Ceramics

The pretreated polyurethane sponge E was soaked in the slurry C prepared in step 1) and maintained for 10 min at room temperature; after hanging pulp, the excess slurry in the sponge was removed by extrusion, and the sponge was dried at 50° C.; repeating processes of hanging pulp and drying for 4 times, a green body of foam ceramics based on barium titanate with even coating and no blocks was obtained.

4) Preparation of Barium Titanate Foam Ceramics

The green body of barium titanate foam ceramics prepared in step 3) was heated from room temperature to 200° C. at a rate of 0.5° C./min, and then raised to 600° C. at a rate of 5° C./min and maintained at 600° C. for 0.5 h; after that, continuously heated to 1300° C. at a rate of 2° C./min and kept at that temperature for 2 h; after the furnace was cooled to room temperature, barium titanate foam ceramics were obtained.

### Embodiment 12

1) Preparation of Slurries

20 g of barium titanate (the average diameter is 100 nm) and 6 g of aqueous methyl cellulose solution with a concentration of 15 wt % were sufficiently ground to obtain a slurry A; 16 g of aqueous carboxymethyl cellulose solution with a concentration of 0.5 wt % was added into the slurry A, and the mixture was sufficiently ground to obtain a slurry B; 10 g of aqueous polyacrylamide solution with a concentration of 0.5 wt % and 6 g of aqueous polyacrylic acid amine solution with a concentration of 0.5 wt % were added into the slurry B, and the mixture was sufficiently ground to obtain a slurry C.

2) Treatment of Polyurethane Sponge

The polyurethane sponge having a specification of 25 PPI was soaked in an aqueous sodium hydroxide solution with a concentration of 10 wt %, and then heated up to 60° C. and kept at that temperature for 3.5 h; the polyurethane sponge was taken out and washed with deionized water, following by drying to obtain a polyurethane sponge D; at room temperature, the polyurethane sponge D was soaked in an aqueous polyethyleneimine solution with a concentration of 0.5 wt % for 3 h; then took out and removed the excess polyethyleneimine solution, after dried at 40° C., a pretreated polyurethane sponge E was obtained.

3) Preparation of Green Body of Barium Titanate Foam Ceramics

The pretreated polyurethane sponge E was soaked in the slurry C prepared in step 1) and maintained for 5 min at room temperature; after hanging pulp, the excess slurry in the sponge was removed by extrusion, and the sponge was dried at 80° C.; repeating processes of hanging pulp and drying for 4 times, a green body of foam ceramics based on barium titanate with even coating and no blocks was obtained.

4) Preparation of Barium Titanate Foam Ceramics

The green body of barium titanate foam ceramics prepared in step 3) was heated from room temperature to 200° C. at a rate of 5° C./min, and then raised to 600° C. at a rate of 5° C./min and maintained at 600° C. for 0.5 h; after that, continuously heated to 1000° C. at a rate of 10° C./min and kept at that temperature for 2 h; after the furnace was cooled to room temperature, barium titanate foam ceramics were obtained.

### Embodiment 13

1) Preparation of Slurries

20 g of barium titanate (the average diameter is 30 nm) and 10 g of aqueous carboxymethyl cellulose solution with a concentration of 1 wt % and 10 g of aqueous methyl cellulose solution with a concentration of 1 wt % were sufficiently ground to obtain a slurry A; 2 g of aqueous carboxymethyl cellulose solution with a concentration of 2 wt % was added into the slurry A, and the mixture was sufficiently ground to obtain a slurry B; 10 g of aqueous polyacrylamide solution with a concentration of 1 wt % and 6 g of aqueous polyethyleneimine solution with a concentration of 1 wt % were added into the slurry B, and the mixture was sufficiently ground to obtain a slurry C.

2) Treatment of Polyurethane Sponge

The polyurethane sponge having a specification of 35 PPI was soaked in an aqueous sodium hydroxide solution with a concentration of 15 wt %, and then heated up to 60° C. and kept at that temperature for 3.5 h; the polyurethane sponge was taken out and washed with deionized water, following by drying to obtain a polyurethane sponge D; at room temperature, the polyurethane sponge D was soaked in a mixed solution by equal volume of aqueous carboxymethyl cellulose solution with a concentration of 1 wt % and aqueous polyethyleneimine solution with a concentration of 1 wt % for 3 h; then took out and removed the excess mixed solution of carboxymethyl cellulose solution and polyethyleneimine solution, after dried at 60° C., a pretreated polyurethane sponge E was obtained.

3) Preparation of Green Body of Barium Titanate Foam Ceramics

The pretreated polyurethane sponge E was soaked in the slurry C prepared in step 1) and maintained for 10 min at room temperature; after hanging pulp, the excess slurry in the sponge was removed by extrusion, and the sponge was dried at 50° C.; repeating processes of hanging pulp and drying for 4 times, a green body of foam ceramics based on barium titanate with even coating and no blocks was obtained.

4) Preparation of Barium Titanate Foam Ceramics

The green body of barium titanate foam ceramics prepared in step 3) was heated from room temperature to 200° C. at a rate of 2° C./min, and then raised to 600° C. at a rate of 1° C./min and maintained at 600° C. for 1 h; after that, continuously heated to 1000° C. at a rate of 2° C./min and kept at that temperature for 1 h; after the furnace was cooled to room temperature, barium titanate foam ceramics were obtained.

### Embodiment 14

1) Preparation of Slurries

20 g of barium titanate (the average diameter is 50 nm) and 6 g of aqueous polyvinyl alcohol solution with a concentration of 10 wt % and 10 g of aqueous carboxymethyl cellulose solution with a concentration of 1 wt % were sufficiently ground to obtain a slurry A; 5 g of aqueous carboxymethyl cellulose solution with a concentration of 2 wt % was added into the slurry A, and the mixture was sufficiently ground to obtain a slurry B; 5 g of aqueous polyacrylamide solution with a concentration of 1 wt % and 5 g of aqueous polyethyleneimine solution with a concentration of 1 wt % were added into the slurry B, and the mixture was sufficiently ground to obtain a slurry C.

2) Treatment of Polyvinyl Chloride Sponge

The polyvinyl chloride sponge having a specification of 15 PPI was soaked in an aqueous sodium hydroxide solution with a concentration of 20 wt %, and then heated up to 60° C. and kept at that temperature for 2 h; the polyvinyl chloride sponge was taken out and washed with deionized water, following by drying to obtain a polyvinyl chloride D; at room temperature, the polyvinyl chloride D was soaked in an aqueous carboxymethyl cellulose solution with a concentration of 0.5 wt % for 3 h; then took out and removed the excess carboxymethyl cellulose solution, after dried at 60° C., the pretreated polyvinyl chloride sponge E was obtained.

3) Preparation of Green Body of Barium Titanate Foam Ceramics

The pretreated polyvinyl chloride sponge E was soaked in the slurry C prepared in step 1) and maintained for 5 min at room temperature; after hanging pulp, the excess slurry in the sponge was removed by extrusion, and the sponge was dried at 40° C.; repeating processes of hanging pulp and drying for 4 times, a green body of foam ceramics based on barium titanate with even coating and no blocks was obtained.

4) Preparation of Barium Titanate Foam Ceramics

The green body of barium titanate foam ceramics prepared in step 3) was heated from room temperature to 200° C. at a rate of 0.5° C./min, and then raised to 600° C. at a rate of 5° C./min and maintained at 600° C. for 2 h; after that, continuously heated to 1200° C. at a rate of 5° C./min and kept at that temperature for 2 h; after the furnace was cooled to room temperature, barium titanate foam ceramics were obtained.

### Embodiment 15

1) Preparation of Slurries

20 g of barium titanate (the average diameter is 30 nm) and 24 g of aqueous methyl cellulose solution with a concentration of 1 wt % were sufficiently ground to obtain a slurry A; 2 g of aqueous hydroxyhexyl cellulose solution with a concentration of 3 wt % was added into the slurry A, and the mixture was sufficiently ground to obtain a slurry B; 16 g of aqueous polyethyleneimine solution with a concentration of 0.5 wt % was added into the slurry B, and the mixture was sufficiently ground to obtain a slurry C.

2) Treatment of Polystyrene Sponge

The polystyrene sponge having a specification of 25 PPI was soaked in an aqueous sodium hydroxide solution with a concentration of 5 wt %, and then heated up to 75° C. and kept at that temperature for 6 h; the polystyrene sponge was taken out and washed with deionized water, following by drying to obtain a polystyrene sponge D; at room temperature, the polystyrene sponge D was soaked in an aqueous polyethyleneimine solution with a concentration of 3 wt % for 2 h; then took out and removed the excess polyethyleneimine solution, after dried at 60° C., the pretreated polystyrene sponge E was obtained.

3) Preparation of Green Body of Barium Titanate Foam Ceramics

The pretreated polystyrene sponge E was soaked in the slurry C prepared in step 1) and maintained for 10 min at room temperature; after hanging pulp, the excess slurry in the sponge was removed by extrusion, and the sponge was dried at 50° C.; repeating processes of hanging pulp and drying for 7 times, a green body of foam ceramics based on barium titanate with even coating and no blocks was obtained.

4) Preparation of Barium Titanate Foam Ceramics

The green body of barium titanate foam ceramics prepared in step 3) was heated from room temperature to 200° C. at a rate of 0.5° C./min, and then raised to 600° C. at a rate of 5° C./min and maintained at 600° C. for 2 h; after that, continuously heated to 1000° C. at a rate of 10° C./min and kept at that temperature for 5 h; after the furnace was cooled to room temperature, barium titanate foam ceramics were obtained.

### Embodiment 16

1) Preparation of Slurries

20 g of barium titanate (the average diameter is 50 nm) and 6 g of aqueous polyvinyl alcohol solution with a concentration of 15 wt % were sufficiently ground to obtain a slurry A; 16 g of aqueous hydroxyhexyl cellulose solution with a concentration of 0.5 wt % was added into the slurry A, and the mixture was sufficiently ground to obtain a slurry B; 4 g of aqueous polyacrylic acid amine solution with a concentration of 3 wt % was added into the slurry B, and the mixture was sufficiently ground to obtain a slurry C.

2) Treatment of Polyvinyl Chloride Sponge

The polyvinyl chloride sponge having a specification of 25 PPI was soaked in an aqueous sodium hydroxide solution with a concentration of 20 wt %, and then heated up to 50° C. and kept at that temperature for 2 h; the polyvinyl chloride sponge was taken out and washed with deionized water, following by drying to obtain a polyvinyl chloride sponge D; at room temperature, the polyvinyl chloride sponge D was soaked in an aqueous polyethyleneimine solution with a concentration of 0.5 wt % for 2 h; then took out and removed the excess polyethyleneimine solution, after dried at 80° C., the pretreated polyvinyl chloride sponge E was obtained.

3) Preparation of Green Body of Barium Titanate Foam Ceramics

The pretreated polyvinyl chloride sponge E was soaked in the slurry C prepared in step 1) and maintained for 1 min at room temperature; after hanging pulp, the excess slurry in the sponge was removed by extrusion, and the sponge was dried at 80° C.; repeating processes of hanging pulp and drying for 1 times, a green body of foam ceramics based on barium titanate with even coating and no blocks was obtained.

4) Preparation of Barium Titanate Foam Ceramics

The green body of barium titanate foam ceramics prepared in step 3) was heated from room temperature to 100° C. at a rate of 5° C./min, and then raised to 500° C. at a rate of 0.5° C./min and maintained at 500° C. for 0.5 h; after that, continuously heated to 1500° C. at a rate of 10° C./min and kept at that temperature for 2 h; after the furnace was cooled to room temperature, barium titanate foam ceramics were obtained.

### Embodiment 17

1) Preparation of Slurries

20 g of barium titanate (the average diameter is 100 nm) and 15 g of aqueous polyvinyl alcohol solution with a concentration of 10 wt % were sufficiently ground to obtain a slurry A; 10 g of aqueous carboxymethyl cellulose solution with a concentration of 1 wt % was added into the slurry A, and the mixture was sufficiently ground to obtain a slurry B; 5 g of aqueous polyacrylic acid amine solution with a concentration of 2 wt % was added into the slurry B, and the mixture was sufficiently ground to obtain a slurry C.

2) Treatment of Polyurethane Sponge

The polyurethane sponge having a specification of 25 PPI was soaked in an aqueous sodium hydroxide solution with a concentration of 15 wt %, and then heated up to 60° C. and kept at that temperature for 3.5 h; the polyurethane sponge was taken out and washed with deionized water, following by drying to obtain a polyurethane sponge D; at room temperature, the polyurethane sponge D was soaked in an aqueous polyethyleneimine solution with a concentration of 0.5 wt % for 6 h; then took out and removed the excess polyethyleneimine solution, after dried at 60° C., a pretreated polyurethane sponge E was obtained.

3) Preparation of Green Body of Barium Titanate Foam Ceramics

The pretreated polyurethane sponge E was soaked in the slurry C prepared in step 1) and maintained for 5 min at room temperature; after hanging pulp, the excess slurry in the sponge was removed by extrusion, and the sponge was dried at 40° C.; repeating processes of hanging pulp and drying for 7 times, a green body of foam ceramics based on barium titanate with even coating and no blocks was obtained.

4) Preparation of Barium Titanate Foam Ceramics

The green body of barium titanate foam ceramics prepared in step 3) was heated from room temperature to 300° C. at a rate of 2° C./min, and then raised to 700° C. at a rate of 2° C./min and maintained at 700° C. for 2 h; after that, continuously heated to 1200° C. at a rate of 8° C./min and kept at that temperature for 3 h; after the furnace was cooled to room temperature, barium titanate foam ceramics were obtained.

What we claim:

1. A preparation method of barium titanate foam ceramics, comprising the following steps:
(1) by weight, 100 parts of nano barium titanate and 30 to 120 parts of an aqueous solution of organic binder with a concentration of 1 to 15 wt % are sufficiently ground to obtain a slurry A; 10 to 80 parts of an aqueous solution of organic rheological agent with a concentration of 0.5 to 3 wt % are added into the slurry A, and the mixture is sufficiently ground to obtain a slurry B; 20 to 80 parts of an aqueous solution of organic dispersant with a concentration of 0.5 to 3 wt % are added into the slurry B, and the mixture is sufficiently ground to obtain a slurry C;
(2) a polymer sponge having a specification of 15 to 35 PPI is soaked in an aqueous solution of sodium hydroxide with a concentration of 5 to 20 wt %, and then heated up to 50 to 75° C. and kept at that temperature for 2 to 6 h, the polymer sponge is taken out and washed with deionized water, dried to obtain a polymer sponge D; at room temperature, the polymer sponge D is soaked in an aqueous surfactant solution with a concentration of 0.5 to 3 wt % for 2 to 6 h, then taken out and removing the excess surfactant, after dried at 40 to 80° C., a pretreated polymer sponge E is obtained;
(3) the pretreated polymer sponge E is soaked in the slurry C prepared in step (1), and maintained for 1 to 10 min at room temperature, after hanging pulp, the excess slurry in the sponge is removed by extrusion, and the sponge is dried at 40 to 80° C.; repeating the processes of hanging pulp and drying for 1 to 7 times to obtain a green body of foam ceramics based on barium titanate;
(4) the green body of barium titanate foam ceramics prepared in step (3) is heated from room temperature to 100-300° C. at a rate of 0.5-5° C./min, and then raised to 500-700° C. at a rate of 0.5-5° C./min and maintained at 500-700° C. for 0.5-2 h, after that, continuously heated to 1000-1500° C. at a rate of 2-10° C./min and kept at 1000-1500° C. for 1-5 h, cool with the furnace to room temperature to obtain barium titanate foam ceramics.

2. The preparation method of barium titanate foam ceramics according to claim 1, wherein the polymer material of said polymer sponge is selected from polyurethane, polystyrene, or polyvinyl chloride.

3. The preparation method of barium titanate foam ceramics according to claim 1, wherein the average diameter of said nano barium titanate is less than or equal to 100 nm.

4. The preparation method of barium titanate foam ceramics according to claim 1, wherein said organic binder is one or more selected from polyvinyl alcohol, carboxymethyl cellulose and methyl cellulose.

5. The preparation method of barium titanate foam ceramics according to claim 1, wherein said organic rheological agent is one or more selected from carboxymethyl cellulose and hydroxyhexyl cellulose.

6. The preparation method of barium titanate foam ceramics according to claim 1, wherein said organic dispersant is one or more selected from polyethyleneimine, polyacrylamide and polyacrylic acid amine.

7. The preparation method of barium titanate foam ceramics according to claim 1, wherein said surfactant is one or more selected from carboxymethyl cellulose and polyethyleneimine.

8. Barium titanate foam ceramics prepared through the preparation method according to claim 1.
